(19) United States
(12) Patent Application Publication
(10) Pub. No.: US 2012/0015173 A1
(43) Pub. Date: Jan. 19, 2012

(54) Method and Apparatus for Moulding Soft Toy Parts

(76) Inventor: Chor-Ming Ma, Kowloon (HK)

(21) Appl. No.: 12/839,045

(22) Filed: Jul. 19, 2010

(51) Int. Cl. B32B 27/30; B29C 67/20

(52) U.S. Cl. 428/319.7; 264/321; 425/112

(57) ABSTRACT

A method of moulding a plastics part provides mating pressure plates, at least one of which has a mould cavity. The pressure plates are maintained at a substantially constant cooling temperature. The plastics blank is pre-heated to a moulding temperature and thereafter placed between the pressure plates which are forced together to form the plastics part in the mould cavity.

### BACKGROUND OF THE INVENTION

The present invention relates to a method of manufacturing plastics parts such as soft flexible toy throwing stars or other slim parts made of soft foam material such as EVA (Ethylene-vinyl acetate). The invention more particularly, although not exclusively, relates to a method of moulding such parts more efficiently.

The current standard method of producing such a toy throwing star as an example is illustrated in FIGS. 1 to 6. A die 11 is used to cut a uniformly thick sheet 10 of EVA foam to the outline of the final product. The thickness of the sheet is equal to or larger than that of the finished product. The die-cut shape 12 might be further hole-punched with a die 13 to form an aperture 14. The part 12 is then placed into a mould cavity 18 in the bottom aluminium plate 15b of a high-pressure moulding press. An upper aluminium plate 15a (also having a corresponding mould cavity) is then forced down under high pressure so that the part 12 takes up the available space of the mating cavities. The plates 15a and 15b are then heated to about 130° C. for about seven minutes. To this end, the plates might be heated externally or have internal electric heating elements receiving current indicated at 17a and 17b.

The plates 15a and 15b must then be cooled to room temperature. To this end, each plate is provided with internal coolant galleries through which coolant flows—entering and exiting via plumbing 16. This process typically takes about four minutes.

The plates 15a and 15b are then opened to release the finished part 12 having a contoured shape with decorative surface patterns 19 corresponding to features provided in the mould cavities 18. The process is then repeated to produce more articles.

A disadvantage of the above method is long (typically twelve minute) lead time due to the repeated heating (seven minutes) and cooling (four minutes) cycles and another one minute for handling the EVA sheet and its off-cuts.

Another disadvantage is short life of the aluminium plates 15a and 15b due to repeated heating and cooling which causes cracks to form inside the mould cavities 18.

Another disadvantage is the requirement for high force to close the plates 15a and 15b.

Also, uneven thickness of the plates 15 results in non-uniformity in the decorative patterns 19 produced.

Furthermore, defects appear if the worker does not load the die-cut part 12 carefully into the mould cavity 18.

### SUMMARY OF THE DISCLOSURE

There is disclosed herein a method of moulding a plastics part, comprising:

providing mating pressure plates, at least one of which has a mould cavity;

maintaining the pressure plates at a substantially constant cooling temperature;

pre-heating a plastics blank to a moulding temperature;

placing the pre-heated plastics blank between the pressure plates;

forcing the pressure plates together to form the plastics blank into a plastics part within the mould cavity;

releasing the part from between the pressure plates and cooling it or allowing it to cool naturally to room temperature.

Preferably, the pressure plates are maintained at a substantially constant cooling temperature by passing coolant through them.

Preferably, the plastics blank is a sheet of EVA foam.

Preferably, the substantially constant cooling temperature is approximately 20° C.

Preferably, the moulding temperature is approximately 120° C.

Preferably, the plastics part is maintained between the pressure plates for a finite duration prior to the releasing step.

Preferably, the finite duration is about four minutes.

Preferably, at least one of the pressure plates has a peripheral thinning formation around or substantially aligned with the periphery of the mould cavity which thins or displaces excess material around the periphery of the plastics part when the plates are forced together.

Preferably, both pressure plates comprise mutually aligned thinning or peripheral thinning formations.

Preferably, both pressure plates comprise mutually aligned mould cavities.

Preferably, the mould cavity includes features producing a decorative surface pattern in the part.

There is further disclosed herein an apparatus for moulding a plastics part, comprising:

mating pressure plates, at least one of which has a mould cavity;

means for forcing the pressure plates together to form a moulded plastics part within the cavity; and

cooling means for maintaining the pressure plates at a substantially constant cooling temperature.

Preferably, at least one of the pressure plates has a peripheral thinning formation around or substantially aligned with a periphery of the mould cavity.

### BRIEF DESCRIPTION OF THE DRAWINGS

A preferred form of the present invention will now be described by way of example with reference to the accompanying drawings, wherein:

FIGS. 1 to 6 schematically depict steps of the known prior art method as discussed above; and

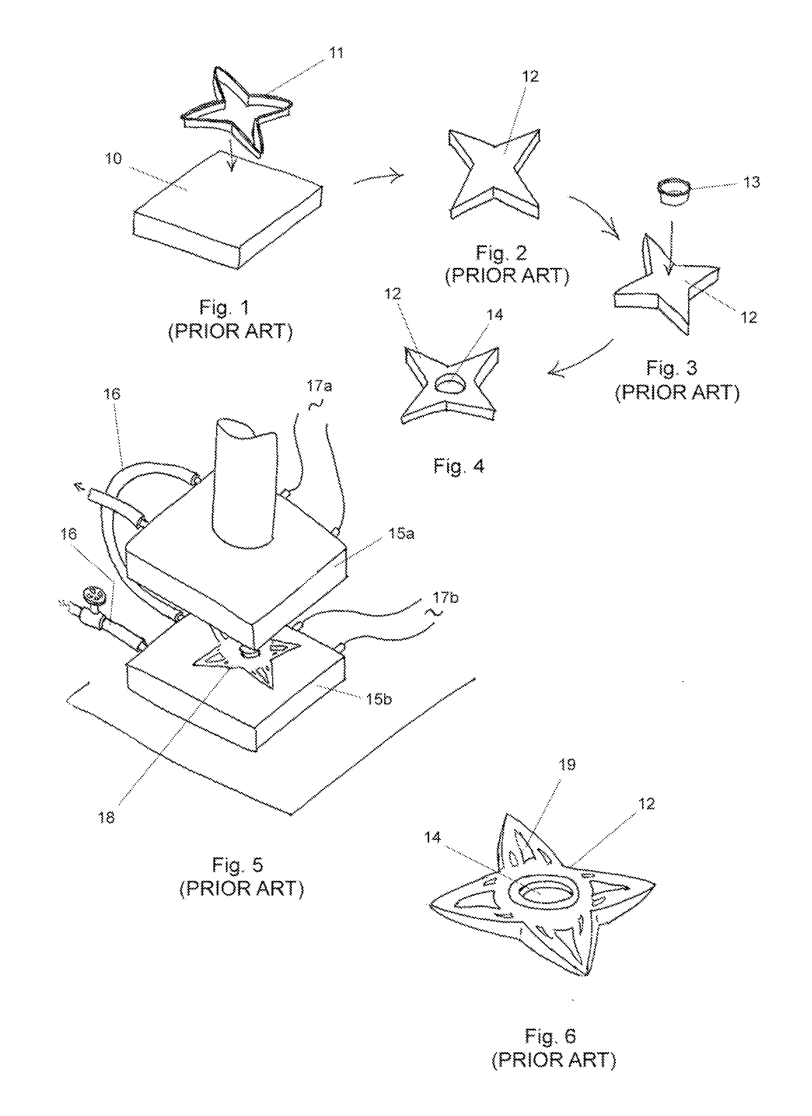

FIGS. 7 to 12 schematically depict the process steps in forming plastics parts by the new method.

### DESCRIPTION OF THE PREFERRED EMBODIMENT

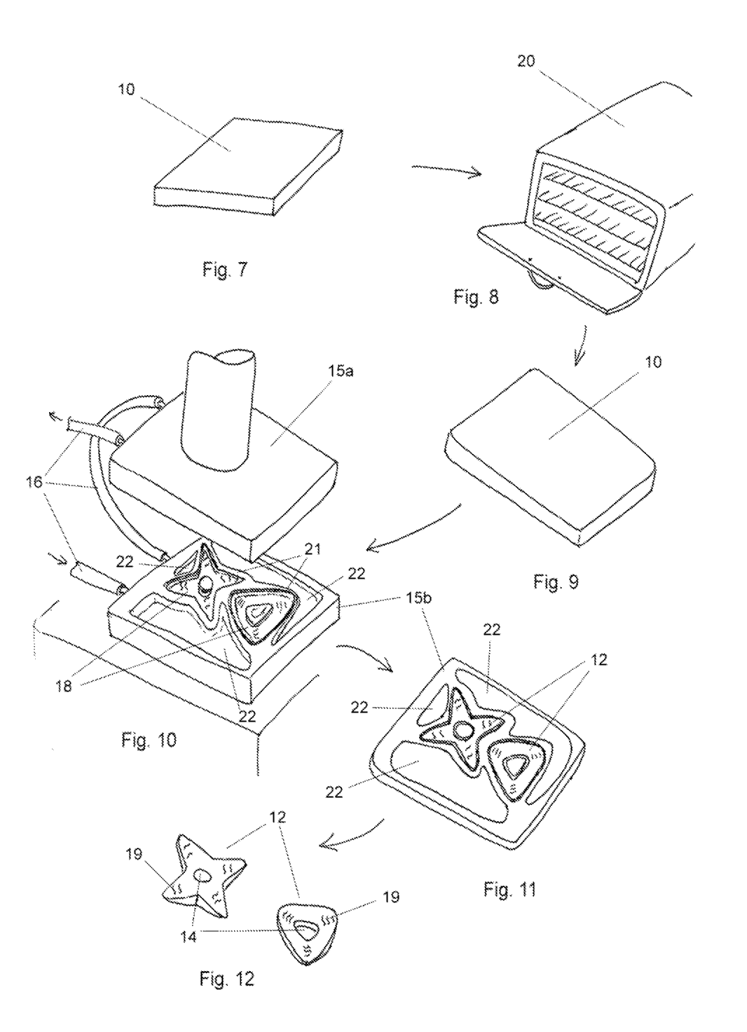

FIGS. 7 to 12 of the accompanying drawings depict schematically the various steps in the new method of forming moulded EVA throwing stars.

A sheet or “blank” 10 of EVA foam of constant thickness is heated in an oven 20 to approximately 120° C.

A moulding press includes an upper aluminium plate 15a and a lower aluminium plate 15b. Each of these includes a pair of mould cavities 18 surrounded by peripheral thinning formations 21. Surrounding the thinning formations 21 are recesses 22. Each mould cavity 18 can include large features such as central aperture-forming dies and fine surface pattern formations. Coolant galleries (not shown) are located internally of each plate 15a and 15b. Coolant such as water is circulated via plumbing 16 through these galleries so as to maintain the plates at a substantially constant temperature of 20° C. A radiator and/or other coolant temperature-control apparatus and recirculating pump for example can be provided externally.

The heated and softened EVA foam blank 10 (without any prior die-cutting) is placed upon the lower plate 15b. The upper plate 15a is pressed down upon the softened blank 10 so that the soft foam fills the mould cavities 18 as the peripheral thinning formations 21 form thin and easily frangible edges or “flash” strips at the immediate periphery of the parts. The bulk of the excess material outboard of the flash is taken up by the recesses 22 and is then set aside to be recycled. The plates 15a and 15b are retained in the closed position for approximately four minutes. During this time the plates are maintained at a substantially constant temperature of approximately 20° C. due to the coolant flowing through the galleries. After approximately four minutes, the plate 15a is raised and the moulded parts 12 are released. If the moulded parts are still hotter than room temperature, they can further cool naturally. Fine surface patterns 19 and central apertures 14 are formed on the part during the moulding process.

Compared to the prior art method, the plate-closing pressure is relatively low due to the softness of the pre-heated blank.

It should be appreciated that modifications and alterations obvious to those skilled in the art are not to be considered as beyond the scope of the present invention. For example, for flat-sided parts only one of the pressure plates 15a or 15b need be provided with mould cavities and peripheral thinning formations. As a further alternative, one of the plates might be provided with mould cavities and the other plate provided with the peripheral thinning formations. Also, the method is not limited in its application to the use of EVA foam as any plastics material having similar moulding capabilities can also be accommodated.

1. A method of moulding a plastics part, comprising:
providing mating pressure plates, at least one of which has a mould cavity;
maintaining the pressure plates at a substantially constant cooling temperature;
pre-heating a plastics blank to a moulding temperature;
placing the pre-heated plastics blank between the pressure plates;
forcing the pressure plates together to form the plastics blank into a plastics part within the mould cavity;
releasing the part from between the pressure plates and cooling it or allowing it to cool naturally to room temperature.

2. The method of claim 1, wherein the pressure plates are maintained at a substantially constant cooling temperature by passing coolant through them.

3. The method of claim 1, wherein the plastics blank is a sheet of EVA foam.

4. The method of claim 1, wherein the substantially constant cooling temperature is approximately 20° C.

5. The method of claim 1, wherein the moulding temperature is approximately 120° C.

6. The method of claim 1, wherein the plastics part is maintained between the pressure plates for a finite duration prior to the releasing step.

7. The method of claim 6, wherein the finite duration is about four minutes.

8. The method of claim 1, wherein at least one of the pressure plates has a peripheral thinning formation around or substantially aligned with the periphery of the mould cavity which thins or displaces excess material around the periphery of the plastics part when the plates are forced together.

9. The method of claim 8, wherein both pressure plates comprise mutually aligned thinning or peripheral thinning formations.

10. The method of claim 1, wherein both pressure plates comprise mutually aligned mould cavities.

11. The method of claim 1, wherein the mould cavity includes features producing a decorative surface pattern in the part.

12. A plastics part produced by the method of claim 1.

13. Apparatus for moulding a plastics part, comprising:
mating pressure plates, at least one of which has a mould cavity;
means for forcing the pressure plates together to form a moulded plastics part within the cavity; and
cooling means for maintaining the pressure plates at a substantially constant cooling temperature.

14. The apparatus of claim 13, wherein at least one of the pressure plates has a peripheral thinning formation around or substantially aligned with a periphery of the mould cavity.

15. A plastics part produced by the method of claim 2.

16. A plastics part produced by the method of claim 3.

17. A plastics part produced by the method of claim 4.

18. A plastics part produced by the method of claim 5.

19. A plastics part produced by the method of claim 6.

20. A plastics part produced by the method of claim 7.
